(19) United States
(12) Patent Application Publication
(10) Pub. No.: US 2018/0129726 A1
(43) Pub. Date: May 10, 2018

(54) LOCAL ANALYSIS SERVER, CENTRAL ANALYSIS SERVER, AND DATA ANALYSIS METHOD

(71) Applicant: ELECTRONICS AND TELECOMMUNICATIONS RESEARCH INSTITUTE, Daejeon (KR)

(72) Inventors: Junyong PARK, Daejeon (KR); Ok Gee MIN, Daejeon (KR)

(73) Assignee: ELECTRONICS AND TELECOMMUNICATIONS RESEARCH INSTITUTE, Daejeon (KR)

(21) Appl. No.: 15/787,127

(22) Filed: Oct. 18, 2017

(30) Foreign Application Priority Data
Nov. 8, 2016 (KR) 10-2016-0148306

(51) Int. Cl. G06F 17/30; G06K 9/62; G06F 17/18

(52) U.S. Cl. CPC G06F 17/30598; G06F 17/18; G06K 9/6221; G06F 17/30867

(57) ABSTRACT

A local analysis server includes: a communicator for communicating with a plurality of devices and a central analysis server; and a controller for transmitting data collected from the plurality of devices to the central analysis server, receiving an analysis model including cluster information on a plurality of clusters generated by performing a clustering analysis on the collected data from the central analysis server, reconstructing the plurality of clusters based on the analysis model, and identifying a cluster corresponding to the received data from among the reconstructed clusters through a clustering analysis on the data received from the plurality of devices.

### CROSS-REFERENCE TO RELATED APPLICATION

This application claims priority to and the benefit of Korean Patent Application No. 10-2016-0148306 filed in the Korean Intellectual Property Office on Nov. 8, 2016, the entire contents of which are incorporated herein by reference.

### BACKGROUND

### (a) Field

An exemplary embodiment of the present invention relates to a local analysis server, a central analysis server, and a data analysis method. More particularly, the exemplary embodiment of the present invention relates to a local analysis server, a central analysis server, and a data analysis method for classifying and analyzing data.

### (b) Description of the Related Art

Sensor data are periodically collected and stored in an Internet of Things (IoT) environment. There may be many data that are beyond prediction through analysis from among the collected sensor data. One of such reasons is that the analysis model used for analysis frequently has a structure that is difficult to realize such as a nonlinear structure, and not a linear structure or a simple structure to be transmitted with a support vector.

Large-capacity sensor data in the IoT environment have a huge amount of data, so it is difficult for the IoT devices to cluster them and analyze them in real time. Further, a server of a service provider processes the large-capacity sensor data, a substantial distance between the IoT devices for transmitting sensor data and the server of the service provider or a distance on a network is very big, so a case of failing to quickly processing the IoT data is frequently generated.

Accordingly, a method for disposing a local server provided near the IoT devices to communicate with the IoT devices, and processing IoT data through a cooperative analysis with a local server and a main server, has been proposed. However, it is insufficient to perform an analysis on unsupervised, large-capacity, and high-level learning, such as a clustering analysis, according to this method.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a data analysis system for supporting a clustering analysis on large-capacity IoT data in an IoT environment, and a method thereof.

An exemplary embodiment of the present invention provides a local analysis server including: a communicator for communicating with a plurality of devices and a central analysis server; and a controller for transmitting data collected from the plurality of devices to the central analysis server, receiving an analysis model including cluster information on a plurality of clusters generated by performing a clustering analysis on the collected data from the central analysis server, reconstructing the plurality of clusters based on the analysis model, and identifying a cluster corresponding to the received data from among the reconstructed clusters through a clustering analysis on the data received from the plurality of devices.

When the received data are not included in any one of the reconstructed clusters, the controller of the local analysis server may determine the received data to be anomaly data, and may transmit an anomaly data report including the anomaly data to the central analysis server.

The analysis model may include class information of classes mapped on the plurality of clusters, and the controller of the local analysis server may identify the class corresponding to the received data based on the class information, and control an actuator based on class information of the class corresponding to the received data.

The cluster information may include position information on at least one core node with a highest density from among a plurality of nodes selected based on data included in the corresponding cluster and a plurality of edge nodes provided on an edge of the corresponding cluster, and connection information between the at least one core node and the plurality of edge nodes, and the density may correspond to a number of neighbor data provided in a predetermined area with respective data as a center.

The cluster information may further include density weight information mapped on the at least one core node and the plurality of edge nodes, and the density weight may be calculated by applying a probability density function-based weight to the density.

The controller of the local analysis server may acquire the plurality of edge nodes corresponding to the plurality of clusters respectively from the cluster information, and connect the plurality of edge nodes to each other, and thereby reconstruct the clusters.

The controller of the local analysis server may determine the cluster corresponding to the received data from among at least one cluster to which the received data are included from among the reconstructed clusters.

When there are a plurality of clusters to which the received data are included from among the reconstructed clusters, the controller of the local analysis server may acquire the edge nodes provided nearest the received data for a plurality of respective clusters to which the received data are included, and may identify the cluster corresponding to the received data based on the density weight of the edge nodes provided nearest the received data.

When there are a plurality of clusters to which the received data are included from among the reconstructed clusters, the controller acquires the edge nodes provided nearest the received data for a plurality of respective clusters to which the received data are included, and it identifies the cluster corresponding to the received data based on a density weight difference between the edge nodes provided nearest the received data and the corresponding core node.

Another embodiment of the present invention provides a central analysis server including: a communicator disposed within a predetermined distance from a plurality of devices, and communicating with a local analysis server for collecting data from the devices; and a controller for receiving data collected from the plurality of devices from the local analysis server, generating a plurality of clusters through a clustering analysis on the data collected from the devices, and distributing an analysis model including cluster information on the respective clusters to the local analysis server.

The controller of the central analysis server may map classes on the plurality of clusters based on a user input, and may generate the analysis model so as to include class information of the classes mapped on the plurality of clusters.

The controller of the central analysis server may select a population corresponding to respective clusters based on a density of data included in the clusters, may generate a skeleton-shaped graph corresponding to the plurality of respective clusters by using at least one core node with a highest density from among a plurality of nodes selected from the population and a plurality of edge nodes provided on an edge of the respective clusters, and may generate the cluster information so as to include position information of the at least one core node and the plurality of edge nodes and connection information between the at least one core node and the edge nodes, and the density may correspond to a number of neighbor data provided in a predetermined area with respective data as a center.

The controller of the central analysis server may generate the cluster information so as to include density weight information mapped on the at least one core node and the plurality of edge nodes, and the density weight may be calculated by applying a probability density function-based weight to the density.

The controller of the central analysis server may generate the graph by connecting the plurality of edge nodes and a nearest core node.

Yet another embodiment of the present invention provides a data analysis method of an analysis system including a local analysis server provided within a predetermined distance from a plurality of devices, and a central analysis server connected to the local analysis server, including: allowing the local analysis server to collect data from the plurality of devices; allowing the local analysis server to transmit the data collected from the plurality of devices to the central analysis server; allowing the central analysis server to perform a clustering analysis on the data collected from the plurality of devices and generate a plurality of clusters; allowing the central analysis server to distribute an analysis model including cluster information on the respective clusters to the local analysis server; allowing the local analysis server to reconstruct the plurality of clusters based on the analysis model; and allowing the local analysis server to identify the cluster corresponding to the received data from among the plurality of clusters through a clustering analysis on the data received from the plurality of devices.

The data analysis method may further include: when the received data are not included in one of the plurality of reconstructed clusters, allowing the local analysis server to determine the received data to be anomaly data; allowing the local analysis server to transmit an anomaly data report including the anomaly data to a central analysis server; allowing the central analysis server to update the analysis model by use of the anomaly data when receiving the anomaly data report; and allowing the central analysis server to distribute the updated analysis model to the local analysis server.

The data analysis method may further include: allowing the central analysis server to map classes on the respective clusters based on a user input; and allowing the central analysis server to generate the analysis model so as to include class information of classes mapped on the plurality of clusters.

The data analysis method may further include: allowing the local analysis server to identify the class corresponding to the received data based on the class information; and allowing the local analysis server to control an actuator based on class information of the class corresponding to the received data. The data analysis method may further include: allowing the central analysis server to select a population corresponding to respective clusters based on a density of data included in the clusters; allowing the central analysis server to select at least one core node with a highest density from among a plurality of nodes selected from the population and a plurality of edge nodes provided on an edge of the respective clusters; allowing the central analysis server to generate a skeleton-shaped graph corresponding to the plurality of respective clusters by connecting the at least one core node and the plurality of edge nodes; and allowing the central analysis server to generate the cluster information so as to include position information of the at least one core node and the plurality of edge nodes and connection information between the at least one core node and the plurality of edge nodes, wherein the density may correspond to a number of neighbor data provided in a predetermined area with respective data as a center.

The reconstructing may include: allowing the local analysis server to acquire the plurality of edge nodes corresponding to the plurality of respective clusters based on the cluster information; and allowing the local analysis server to reconstruct the plurality of clusters by connecting the plurality of edge nodes corresponding to the plurality of clusters to each other.

### BRIEF DESCRIPTION OF THE DRAWINGS

FIG. 1 shows an IoT environment according to an exemplary embodiment.

FIG. 2 shows a data analysis system according to an exemplary embodiment.

FIG. 3 shows a method for generating an analysis model by a data analysis system according to an exemplary embodiment.

FIG. 4A to FIG. 4D show a method for generating an analysis model by a data analysis system according to an exemplary embodiment.

FIG. 5 shows an analysis method by a data analysis system according to an exemplary embodiment.

FIG. 6 shows an example of reconstructing a cloud by a local analysis server according to an exemplary embodiment.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Unless explicitly described to the contrary, the word “comprise” and variations such as “comprises” or “comprising” will be understood to imply the inclusion of stated elements but not the exclusion of any other elements.

A data analysis system according to an exemplary embodiment, and a method thereof, will be described with reference to accompanying drawings.

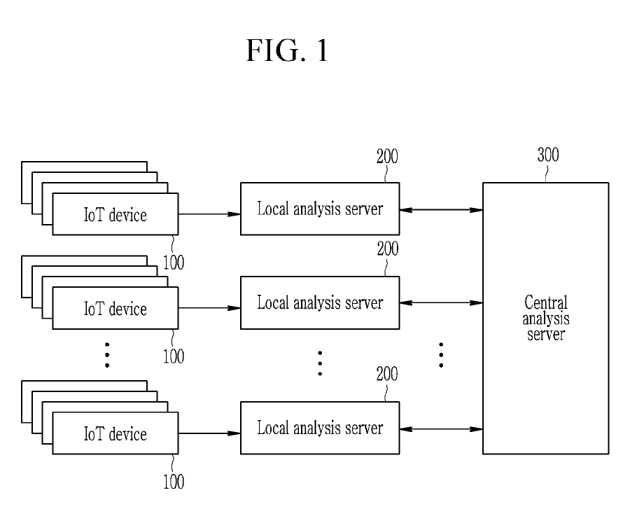

FIG. 1 shows an Internet of Things (IoT) service environment according to an exemplary embodiment.

Referring to FIG. 1, the IoT service environment may include a plurality of IoT devices 100, a plurality of local analysis servers 200, and a central analysis server 300.

The IoT device 100 includes a sensor, and it may acquire IoT data. The IoT data include sensor data acquired by the sensor, and the sensor data may be configured with numerical values.

The IoT device 100 may transmit the IoT data to the local analysis server 200.

The IoT device 100 is a low-power, low-capacity, and low-performance device in most cases. Therefore, the IoT device 100 may communicate with the local analysis server 200 by using a light-weight application communication protocol. For example, the IoT device 100 may perform communication by using a RESTful machine-to-machine (M2M) protocol that is a representational state transfer (REST)-based application communication protocol.

The local analysis server 200 may collect IoT data in a stream data form from the IoT devices 100. The local analysis server 200 may be disposed near the IoT devices 100. For example, the local analysis server 200 may be provided within a range connectable to the IoT devices 100 though a personal area network (PAN) so as to communicate with the IoT devices 100 through the PAN.

When collecting the IoT data in a stream data form from the IoT devices 100, the local analysis server 200 may perform classification and analysis on the same by using an analysis model. When a corresponding class is identified through the classification and analysis on the IoT data, the local analysis server 200 may control an actuator (not shown) so as to perform an actuation corresponding to the identified class.

The local analysis server 200 may determine anomaly data during the classification and analysis process. When the anomaly data are found from among the collected IoT data, the local analysis server 200 may report the finding of anomaly data to the central analysis server 300 to request a reanalysis on the anomaly data.

The local analysis server 200 may process the IoT data in a stream data form collected from the IoT devices 100 as batch data, and may transmit the processed batch data to the central analysis server 300. The batch data represent data generated by stacking the IoT data received as stream data from the IoT devices 100 for a predetermined period of time and processing the same per batch. The local analysis server 200 may generate the batch data by gathering the IoT data collected from the IoT devices 100 for a predetermined time for respective IoT devices or corresponding positions.

The local analysis server 200 may perform a gateway function so as to communicate with the central analysis server 300 through a network such as the World Wide Web (WWW).

The central analysis server 300 may receive batch data from the local analysis server 200. The central analysis server 300 may generate an analysis model or update the same by using the received batch data.

When receiving an anomaly data report from the local analysis server 200, the central analysis server 300 may update the analysis model based upon it.

The central analysis server 300 may distribute the analysis model to the local analysis server 200 so that the analysis model may be used for a classification and analysis by the local analysis server 200.

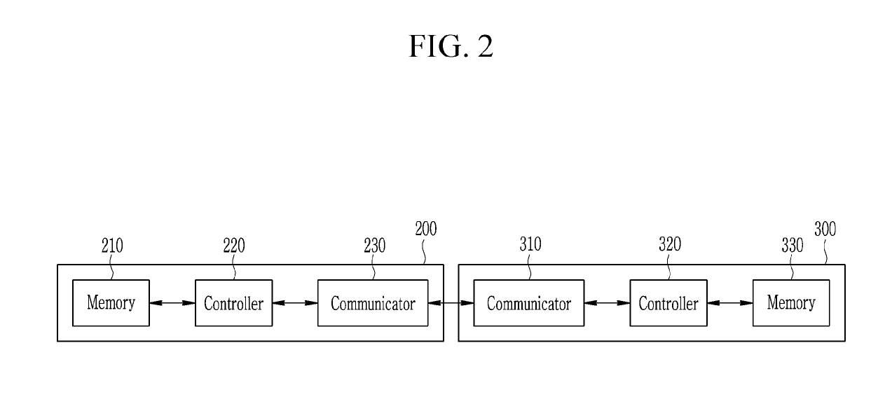

Functions of the data analysis system (including the local analysis server 200 and the central analysis server 300) according to an exemplary embodiment will now be described in detail with reference to FIG. 2.

FIG. 2 shows a data analysis system according to an exemplary embodiment.

Referring to FIG. 2, the data analysis system may include a local analysis server 200 and a central analysis server 300. It has been illustrated for ease of description in FIG. 2 that the data analysis system includes one local analysis server 200, but the present invention is not limited thereto, and the data analysis system may include a plurality of local analysis servers 200.

The local analysis server 200 may include a communicator 210, a controller 220, and a memory 230.

The communicator 210 may perform communication between the local analysis server 200 and the IoT devices 100. For example, the communicator 210 may receive IoT data in a stream data form from the IoT devices 100.

The communicator 220 may perform communication between the local analysis server 200 and the central analysis server 300. For example, the communicator 210 may transmit batch data or an anomaly data report to the central analysis server 300. For another example, the communicator 210 may receive an analysis model distributed by the central analysis server 300.

The controller 220 may control an overall operation of the local analysis server 200.

The controller 220 may collect the IoT data in a stream data form from the IoT devices 100 through the communicator 210.

The controller 220 may process the IoT data received from the IoT devices 100 into a batch data form. Further, the controller 220 may transmit the processed batch data to the central analysis server 300 through the communicator 210.

The controller 220 may receive an analysis model from the central analysis server 300 through the communicator 210, and may store the same in the memory 230. The analysis model distributed by the central analysis server 300 may include information on clusters generated through a clustering analysis, and class information mapped on the respective clusters.

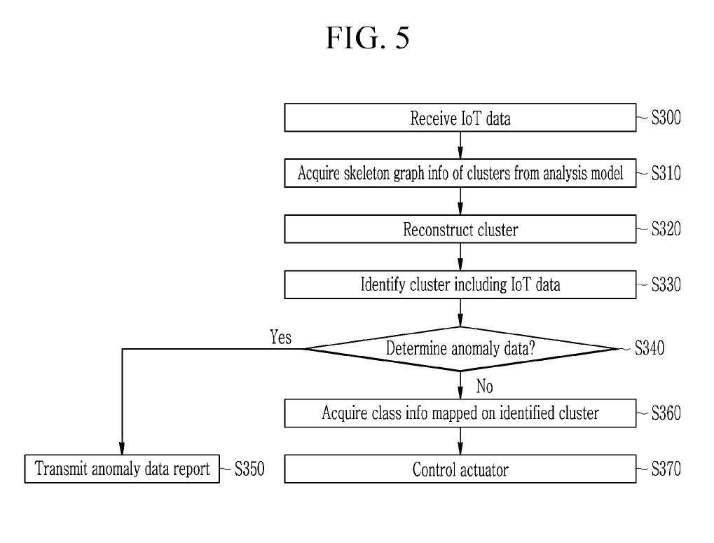

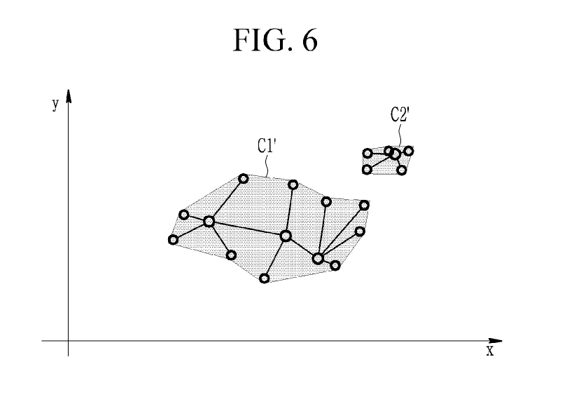

The controller 220 may perform a classification and analysis on the IoT data collected from the IoT devices 100 by using the analysis model. The classifying and analyzing method by the local analysis server 200 will be described in a latter part of the present specification with reference to FIG. 5 and FIG. 6.

When the class corresponding to the IoT data is identified through classification and analysis, the controller 220 may transmit an analysis result to an actuator (not shown) or control the actuator (not shown) so as to perform an actuation corresponding to the class.

When new data that may not be analyzed by use of the analysis model, that is, data that are out of an analysis range of the analysis model, are detected from among the IoT data collected from the IoT devices 100, the controller 220 may determine the same to be anomaly data. When the anomaly data are detected, the controller 220 may transmit an anomaly data report including the IoT data that are determined to be anomaly data to the central analysis server 300 through the communicator 210.

The central analysis server 300 may include a communicator 310, a controller 320, and a memory 330.

The communicator 310 may perform communication between the central analysis server 300 and the local analysis server 200. For example, the communicator 310 may receive batch data or an anomaly data report from the local analysis server 200. For another example, the communicator 310 may transmit an analysis model to the local analysis server 200.

The controller 320 may control an entire operation of the central analysis server 300.

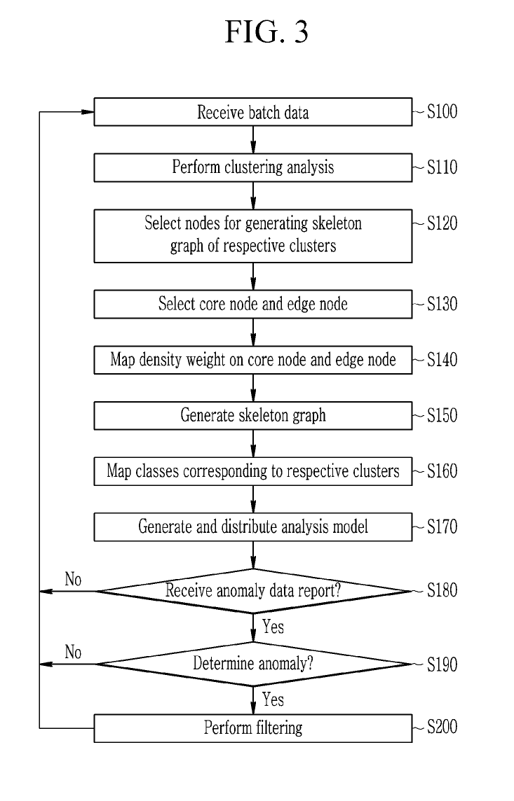

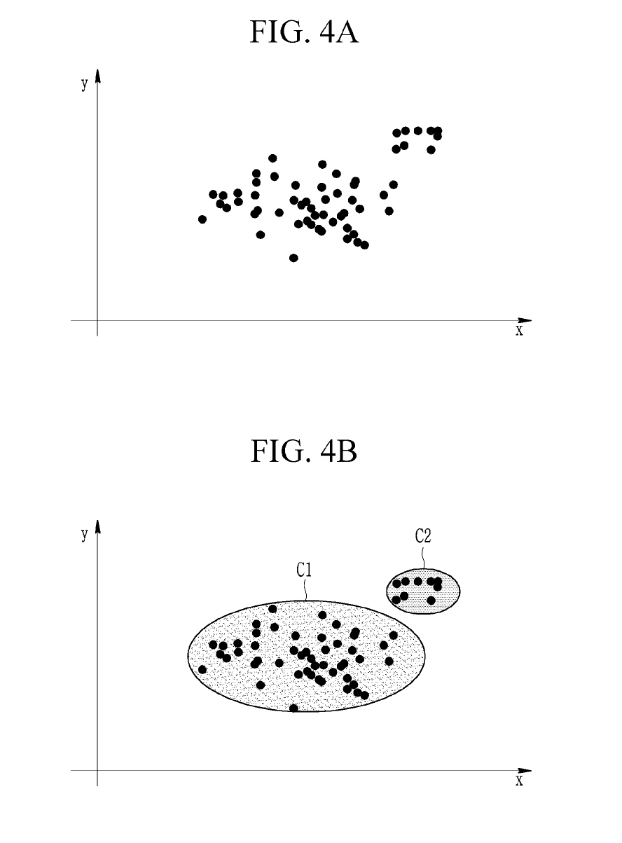

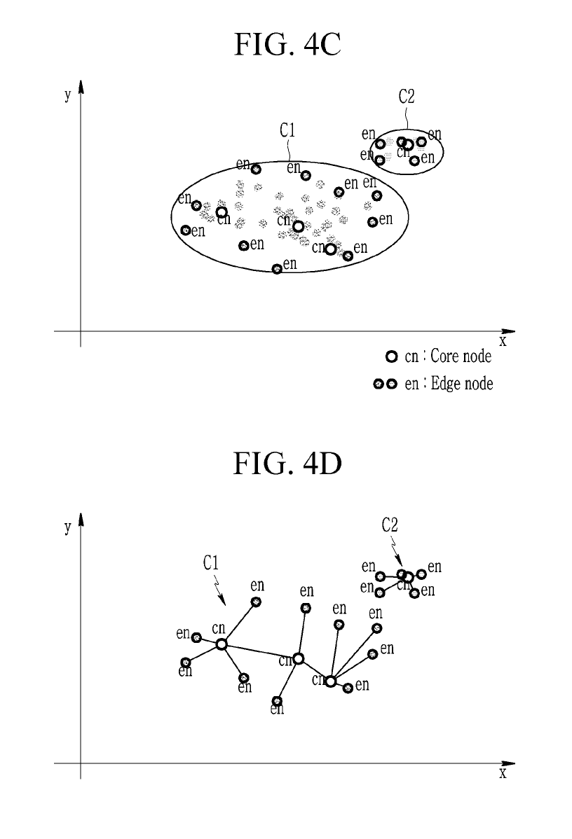

The controller 320 may receive batch data from the local analysis server 200 through the communicator 310, may perform a clustering analysis thereon, and may thereby generate an analysis model or update the same. A method for generating an analysis model according to an exemplary embodiment will be described in detail in a latter part of the present specification with reference to FIG. 3, FIG. 4A, and FIG. 4B.

When an analysis model is generated, the controller 320 may store the same in the memory 330. Further, the controller 320 may distribute the analysis model to the local analysis server 200 through the communicator 310.

Regarding the above-structured data analysis system, the functions of the controller 220 of the local analysis server 200 and the controller 320 of the central analysis server 300 may be respectively performed by a processor realized with at least one central processing unit (CPU), a chipset, or a microprocessor.

A method for generating an analysis model by a data analysis system according to an exemplary embodiment will now be described in detail with reference to FIG. 3 and FIG. 4A to FIG. 4D.

FIG. 3 shows a method for generating an analysis model by a central analysis server according to an exemplary embodiment. FIG. 4A and FIG. 4B show a method for generating an analysis model by a data analysis system according to an exemplary embodiment. The method for generating an analysis model of FIG. 4 may be performed by a controller 320 of the central analysis server 300.

Referring to FIG. 3, as the local analysis server 200 transmits batch data to the central analysis server 300 by a user input, as well as a data capacity limit of the local analysis server 200, the controller 320 of the central analysis server 300 receives the batch data from the local analysis server 200 (S100).

Upon receiving the batch data, the controller 320 forms the batch data into at least one cluster through a clustering analysis (S110).

FIG. 4A shows an example of unprocessed batch data before a clustering analysis, and FIG. 4B shows an example of forming batch data into a cluster. Referring to FIG. 4B, a plurality of clusters C1 and C2 with a predetermined distribution area are generated through a clustering analysis on batch data.

When the clusters are generated through a clustering analysis on the batch data, the controller 320 estimates a distribution area of each cluster and selects nodes for generating a skeleton-shaped graph (a skeleton graph hereinafter) from among the data included in the respective clusters (S120).

In the stage S120, the controller 320 selects a population from among the data included in the respective clusters. The controller 320 may select the data with relatively high density from among the data included in the respective clusters as a population. Here, the density of the respective data corresponds to a number of neighbor data provided in a predetermined area with the data as centers. That is, the controller 320 may select the data with a relatively great number of neighbor data provided in a predetermined area with the data as centers from among the data included in the respective clusters as the population.

In the stage S120, the controller 320 calculates a sample size so as to select a node to be used for generation of a skeleton graph of the respective clusters from among populations when the populations of the respective clusters are selected. The controller 320 may calculate the sample size (n) of the respective clusters through Equation 1 by assuming that the data in the respective clusters have a normal distribution.

$$n \geq {( \frac{{z}_{a} / {2}^{σ}}{δ} )}^{2} \qquad \{ Equation 1 ]$$

Here, Za is a population mean, σ is a substantial estimate, δ and is an allowable error.

The controller 320 may select nodes to be used for generation of a skeleton graph from among the populations of the respective clusters based on the sample size calculated through Equation 1. The controller 320 may select as many populations as the sample size from among the populations of the respective clusters as a node for generating the skeleton graph.

When the nodes used for generation of a skeleton graph of the respective clusters are selected, the controller 320 selects a core node and an edge node therefrom (S130).

In the stage S130, the controller 320 may select at least one of the nodes selected for a generation of a skeleton graph of the respective clusters as a core node. The core node is a node corresponding to a center of the skeleton graph, and the controller 320 may select the data (or node) at the position with the greatest density as a core node.

In the stage S130, the controller 320 may select an edge node from among nodes selected for generating a skeleton graph of respective clusters. The edge node represents a node provided on an edge of each cluster.

When a core node and an edge node are selected, the controller 320 maps a corresponding density weight to each core node and each edge node (S140). Here, the density weight is a unique value of each node, and it may be calculated by applying a probability density function-based weight to the density value of the data provided to each node. For example, the core node may be a node with a density weight that is greater than 95%. For another example, it may be a node with a density weight that is less than 30% of the edge node.

FIG. 4C shows an example of selecting a core node and an edge node for configuring a skeleton graph for each cluster. Referring to FIG. 4C, the core node (cn) may be selected in an area with a relatively high data density, and the edge node (en) may be selected on edges of respective clusters C1 and C2.

When the core node and the edge node for configuring the skeleton graph of respective clusters are selected, the controller 320 connects the edge node to the nearest core node to thus generate a skeleton graph (S150).

FIG. 4D shows a skeleton graph configured by use of core nodes and edge nodes. Referring to FIG. 4D, the skeleton graph of respective clusters may be formed by connecting the core nodes (cn) to each other and connecting the respective edge nodes (en) to the nearest core node (cn). In this instance, when the edge nodes (en) configuring the skeleton graph of respective clusters are connected to each other, a polygonal shape is formed, and the polygonal shape generated at this time may indicate a corresponding cluster shape (or a distribution area).

The controller 320 may generate the skeleton graph for all clusters by performing the stages S120 to S150 to the entire clusters. As described above, the skeleton graph of respective clusters are generated by encoding the data of respective clusters by use of the core node and the edge nodes selected from the respective clusters.

When the skeleton graph of respective clusters is generated as described above, the controller 320 may perform a classification process for mapping a class on the respective clusters based on a user input (S160).

When the classification process on respective clusters is finished, the controller 320 generates an analysis model including cluster information and class information on a plurality of respective clusters. Further, the controller 320 distributes the generated analysis model to the local analysis server 200 (S170). Respective cluster information may include skeleton graph information on the corresponding cluster.

In the stage S170, the controller 320 may generate skeleton graph information of respective clusters including position information of a respective core node and edge node for forming a skeleton graph of each cluster through a matrix transformation, a density weight mapped on the respective core node and edge node, and connection information between the respective core node and edge node.

In the stage S170, the controller 320 may generate class information so as to include identification information (or identification information of the cluster on which each class is mapped) on the class mapped on respective clusters, and actuation information corresponding to the respective classes.

When receiving an anomaly data report from the local analysis server 200 (S180), the controller 320 may perform anomaly determination on the corresponding anomaly data (S190).

In the stage the S190, when the data of the same value reported to be anomaly data are greater than a predetermined number (e.g., a sample size), the controller 320 may determine the corresponding data to not be anomalous. In this case, the controller 320 may update the analysis model by again performing the above-described stages for generating an analysis model (stage S110 to stage S170) including the data that are determined to be not anomalous through the anomaly determination process. When the analysis model is updated, the controller 320 may distribute the updated analysis model to the local analysis server 200 and the local analysis server 200 may perform a classification analysis by use of a new analysis model.

In the stage S190, when the anomaly data are determined to be simple noise in the anomaly determination process, the controller 320 may remove the corresponding data from the data for generating an analysis model through filtering (S200).

A method for analyzing data by using an analysis model distributed by a central analysis server 300 in a local analysis server 200 according to an exemplary embodiment will now be described with reference to FIG. 5 and FIG. 6.

FIG. 5 shows a classifying and analyzing method by a local analysis server according to an exemplary embodiment. FIG. 6 shows an example of reconstructing a cloud by a local analysis server according to an exemplary embodiment. The classifying and analyzing method of FIG. 5 may be performed by the controller 220 of the local analysis server 200.

Referring to FIG. 5, the controller 220 of the local analysis server 200 receives IoT data in a stream data form from the IoT devices 100 (S300).

The controller 220 reads an analysis model from the memory 230 for analysis of the IoT data, and acquires skeleton graph information of respective clusters from the analysis model (S310).

When acquiring skeleton graph information of respective clusters, the controller 220 may use the same to reconstruct the clusters (S320).

In the stage S320, the controller 220 may acquire position information, a density weight, and a connection relationship on the core node and the edge nodes for configuring a skeleton graph of respective clusters based on skeleton graph information of respective clusters included in the analysis model. The controller 220 may dispose the core node and edge nodes based on such information, and may connect the edge node and the core nodes to thereby reconstruct the skeleton graph of respective clusters. Further, the controller 220 may reconstruct the respective clusters by connecting the edge nodes for configuring the skeleton graph of respective clusters.

FIG. 6 shows an example for reconstructing clusters by use of a skeleton graph. Referring to FIG. 6, the controller 220 may reconstruct the skeleton graph of respective clusters by connecting the core nodes of the skeleton graph and connecting the respective edge nodes and the nearest core node. Further, the controller 220 reconstructs the clusters (C1′, C2′) by connecting the edge nodes of the skeleton graph to each other and generating a polygonal cluster area.

When the clusters are reconstructed from the analysis model through the stage S320, the controller 220 may perform a clustering analysis and classification analysis on the received IoT data based on the reconstruction as follows.

When the respective clusters are reconstructed, the controller 220 identifies the cluster to which the IoT data received through a clustering analysis are included (S330).

In the stage S330, when the IoT data are included in an area of one of the reconstructed clusters, the controller 220 identifies the corresponding cluster as a cluster to which the IoT data are included. This is because the IoT data are included in the cluster area generated by use of a skeleton graph, so they have a great probability of being included in an original cluster of the corresponding skeleton graph, and they also have a great probability of being included in the same cluster according to the clustering analysis by the central analysis server 300.

In the stage S330, when the IoT data are included in the area of the reconstructed clusters, the controller 220 selects the edge node that is nearest the IoT data from the skeleton graph of a plurality of clusters to which the IoT data are included. The density weights of the edge node selected among the clusters are compared to each other to thus identify the cluster including the edge node with a high density weight as the cluster to which the IoT data are included.

When the density weights among the edge nodes selected from among a plurality of clusters to which the IoT data are included are the same as each other, the controller 220 may include the IoT data to the cluster with a lesser density weight between the edge node and the core node to which the corresponding edge node is connected.

In the stage S330, when the IoT data are not included in the area of any cluster, the controller 220 may determine the corresponding IoT data to be anomaly data.

When the IoT data are determined to be anomaly data in the clustering analysis process (S340), the controller 220 may transmit an anomaly data report including the corresponding IoT data to the central analysis server 300 (S350).

When the cluster to which the IoT data are included is identified through the stage S330, the controller 220 acquires class information mapped on the identified cluster from the analysis model (S360). The controller 220 controls an actuator (not shown) so as to perform a corresponding action based upon the acquired class information (S370).

As described above, the data analysis system according to an exemplary embodiment allows the central analysis server 300 to consecutively update the analysis model through learning and distribute the same, and allows the local analysis server 200 to perform a classification analysis by using the analysis model distributed by the central analysis server 300 without the process for generating the analysis model or updating the same, thereby allowing a real-time classification analysis on the IoT data. Particularly, the local analysis server 200 may easily combine the probability/density-based clustering analysis corresponding to the high-level unsupervised learning requiring large-capacity-data processing and supervised learning-based classification analysis for mapping the class on the data, and may perform the same.

Further, the central analysis server 300 provides cluster information to the local analysis server 200 by using the skeleton graph that is encoded data of respective simple clusters, and the local analysis server 200 may reconstruct the cluster from the skeleton graph through a simplification process, so it is easy to distribute and reconstruct the analysis model.

In addition, when the anomaly data are generated, the analysis model is consecutively updated by reflecting the anomaly data, so the gradual self-learning effect for allowing a user to react through learning when unexpected data are generated is available.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A local analysis server comprising:
a communicator for communicating with a plurality of devices and a central analysis server; and
a controller for transmitting data collected from the plurality of devices to the central analysis server, receiving an analysis model including cluster information on a plurality of clusters generated by performing a clustering analysis on the collected data from the central analysis server, reconstructing the plurality of clusters based on the analysis model, and identifying a cluster corresponding to the received data from among the reconstructed clusters through a clustering analysis on the data received from the plurality of devices.

2. The local analysis server of claim 1, wherein
when the received data are not included in any one of the reconstructed clusters, the controller determines the received data to be anomaly data, and transmits an anomaly data report including the anomaly data to the central analysis server.

3. The local analysis server of claim 1, wherein
the analysis model includes class information of classes mapped on the plurality of clusters, and
the controller identifies the class corresponding to the received data based on the class information, and controls an actuator based on class information of the class corresponding to the received data.

4. The local analysis server of claim 1, wherein
the cluster information includes position information on at least one core node with a highest density from among a plurality of nodes selected based on data included in the corresponding cluster and a plurality of edge nodes provided on an edge of the corresponding cluster, and connection information between the at least one core node and the plurality of edge nodes, and
the density corresponds to a number of neighbor data provided in a predetermined area with respective data as a center.

5. The local analysis server of claim 4, wherein
the cluster information further includes density weight information mapped on the at least one core node and the plurality of edge nodes, and
the density weight is calculated by applying a probability density function-based weight to the density.

6. The local analysis server of claim 5, wherein
the controller acquires the plurality of edge nodes corresponding to the plurality of clusters respectively from the cluster information, and connects the plurality of edge nodes to each other, and thereby reconstructs the clusters.

7. The local analysis server of claim 5, wherein
the controller determines the cluster corresponding to the received data from among at least one cluster to which the received data are included from among the reconstructed clusters.

8. The local analysis server of claim 7, wherein
when there are a plurality of clusters to which the received data are included from among the reconstructed clusters, the controller acquires the edge nodes provided nearest the received data for a plurality of respective clusters to which the received data are included, and identifies the cluster corresponding to the received data based on the density weight of the edge nodes provided nearest the received data.

9. The local analysis server of claim 7, wherein
when there are a plurality of clusters to which the received data are included from among the reconstructed clusters, the controller of the local analysis server may acquire the edge nodes provided nearest the received data for a plurality of respective clusters to which the received data are included, and it may identify the cluster corresponding to the received data based on a density weight difference between the edge nodes provided nearest the received data and the corresponding core node.

10. A central analysis server comprising:
a communicator disposed within a predetermined distance from a plurality of devices, and communicating with a local analysis server for collecting data from the devices; and
a controller for receiving data collected from the plurality of devices from the local analysis server, generating a plurality of clusters through a clustering analysis on the data collected from the devices, and distributing an analysis model including cluster information on the respective clusters to the local analysis server.

11. The central analysis server of claim 10, wherein
the controller maps classes on the plurality of clusters based on a user input, and generates the analysis model so as to include class information of the classes mapped on the plurality of clusters.

12. The central analysis server of claim 10, wherein
the controller selects a population corresponding to respective clusters based on a density of data included in the clusters, generates a skeleton-shaped graph corresponding to the plurality of respective clusters by using at least one core node with a highest density from among a plurality of nodes selected from the population and a plurality of edge nodes provided on an edge of the respective clusters, and generates the cluster information so as to include position information of the at least one core node and the plurality of edge nodes and connection information between the at least one core node and the edge nodes, and
the density corresponds to a number of neighbor data provided in a predetermined area with respective data as a center.

13. The central analysis server of claim 12, wherein
the controller generates the cluster information so as to include density weight information mapped on the at least one core node and the plurality of edge nodes, and
the density weight is calculated by applying a probability density function-based weight to the density.

14. The central analysis server of claim 12, wherein
the controller generates the graph by connecting the plurality of edge nodes and a nearest core node.

15. A data analysis method of an analysis system including a local analysis server provided within a predetermined distance from a plurality of devices, and a central analysis server connected to the local analysis server, comprising:
allowing the local analysis server to collect data from the plurality of devices;
allowing the local analysis server to transmit the data collected from the plurality of devices to the central analysis server;
allowing the central analysis server to perform a clustering analysis on the data collected from the plurality of devices and generate a plurality of clusters;
allowing the central analysis server to distribute an analysis model including cluster information on the respective clusters to the local analysis server;
allowing the local analysis server to reconstruct the plurality of clusters based on the analysis model; and
allowing the local analysis server to identify the cluster corresponding to the received data from among the plurality of clusters through a clustering analysis on the data received from the plurality of devices.

16. The data analysis method of claim 15, further comprising
when the received data are not included in one of the plurality of reconstructed clusters, allowing the local analysis server to determine the received data to be anomaly data;
allowing the local analysis server to transmit an anomaly data report including the anomaly data to a central analysis server;
allowing the central analysis server to update the analysis model by use of the anomaly data when receiving the anomaly data report; and
allowing the central analysis server to distribute the updated analysis model to the local analysis server.

17. The data analysis method of claim 15, further comprising:
allowing the central analysis server to map classes on the respective clusters based on a user input; and
allowing the central analysis server to generate the analysis model so as to include class information of classes mapped on the plurality of clusters.

18. The data analysis method of claim 17, further comprising:
allowing the local analysis server to identify the class corresponding to the received data based on the class information; and
allowing the local analysis server to control an actuator based on class information of the class corresponding to the received data.

19. The data analysis method of claim 17, further comprising:
allowing the central analysis server to select a population corresponding to respective clusters based on a density of data included in the clusters;
allowing the central analysis server to select at least one core node with a highest density from among a plurality of nodes selected from the population and a plurality of edge nodes provided on an edge of the respective clusters;
allowing the central analysis server to generate a skeleton-shaped graph corresponding to the plurality of respective clusters by connecting the at least one core node and the plurality of edge nodes; and
allowing the central analysis server to generate the cluster information so as to include position information of the at least one core node and the plurality of edge nodes and connection information between the at least one core node and the plurality of edge nodes,
wherein the density corresponds to a number of neighbor data provided in a predetermined area with respective data as a center.

20. The data analysis method of claim 19, wherein
the reconstructing includes:
allowing the local analysis server to acquire the plurality of edge nodes corresponding to the plurality of respective clusters based on the cluster information; and
allowing the local analysis server to reconstruct the plurality of clusters by connecting the plurality of edge nodes corresponding to the plurality of clusters to each other.
